(19) United States
(12) Patent Application Publication
(10) Pub. No.: US 2025/0345761 A1
(43) Pub. Date: Nov. 13, 2025

(54) MIXING APPARATUS, AND METHOD FOR PRODUCING MIXED SOLUTION

(71) Applicant: SUMITOMO SEIKA CHEMICALS CO., LTD., Kako-gun, Hyogo (JP)

(72) Inventors: Kazushi TAKEMOTO, Himeji-shi (JP); Tetsuya TAKECHI, Himeji-shi (JP); Shingo NAGAOKA, Himeji-shi (JP)

(73) Assignee: SUMITOMO SEIKA CHEMICALS CO., LTD., Kako-gun, Hyogo (JP)

(21) Appl. No.: 18/868,642

(22) PCT Filed: Mar. 22, 2023
(86) PCT No.: PCT/JP2023/011305

§ 371 Date: Nov. 22, 2024

(30) Foreign Application Priority Data
May 26, 2022 (JP) 2022-086036

(51) Int. Cl. B01F 35/221; B01F 25/50; B01F 35/71

(52) U.S. Cl. CPC B01F 35/2212; B01F 25/50; B01F 35/2211; B01F 35/712

(57) ABSTRACT

A mixing apparatus includes a material supply line, a mixing tank, a stirring device, and a transportation line. The material supply line supplies two or more kinds of materials including a liquid. The mixing tank accommodates the two or more kinds of materials that have been supplied. The stirring device stirs a mixed solution of the two or more kinds of materials inside the mixing tank. The transportation line transports the mixed solution inside the mixing tank to an outside of the mixing tank. The mixing apparatus maintains a liquid level height of the mixed solution inside the mixing tank at a level falling within a predetermined range by controlling at least one of a supply amount of the two or more kinds of materials to be supplied into the mixing tank and a transportation amount of the mixed solution to be transported to the outside of the mixing tank.

### TECHNICAL FIELD

The present invention relates to a mixing apparatus and a method for producing a mixed solution.

### BACKGROUND ART

Patent Literature 1 discloses a method for producing a polyacrylic acid (salt) based water-absorbent resin having an excellent whiteness degree. The production method according to Patent Literature 1 includes a process of storing or producing acrylic acid, a process of mixing and/or neutralizing acrylic acid containing a polymerization inhibitor, water, a cross-linking agent, and a basic composition to prepare a monomer aqueous solution, a process of polymerizing the monomer aqueous solution, a process of drying an obtained hydrous gel-like crosslinked polymer, a process of performing a surface crosslinking, and the like.

In the process of preparing the above-described monomer aqueous solution, an apparatus 2 or an apparatus 26 is used that includes a neutralization tank 3, a pump 4, a heat exchanger 6, a line mixer 8, a polymerization machine 10, and piping connecting these. In the apparatus 2, an outlet 24 of the neutralization tank 3, the pump 4, the heat exchanger 6 and an inlet 22 of the neutralization tank 3 are connected in this order to form a circulation loop. In the apparatus 2, a pipe branched off from the circulation loop between the heat exchanger 6 and the inlet 22 of the neutralization tank 3 is connected to the downstream line mixer 8 and the polymerization machine 10.

### CITATION LIST

### Patent Literature

Patent Literature 1: WO 2011/040575

### SUMMARY OF THE INVENTION

### Technical Problems

A liquid containing acrylic acid and a basic aqueous solution are continuously supplied to a neutralization system constituting the circulation loop. This produces a mixed solution containing an acrylate produced by a neutralization reaction between acrylic acid and a basic substance. While this mixed solution is stirred inside the neutralization tank 3 and is circulated through the circulation loop, a part of it is also continuously supplied to the polymerization machine 10, and the circulation of the mixed solution and the supply to the polymerization machine simultaneously proceed. While, in the circulation loop, neutralization heat is generated due to the neutralization reaction, by adjusting the temperature of the mixed solution by the heat exchanger 6, the temperature of the mixed solution in the circulation loop can be maintained within a desired range, and a predetermined neutralization rate can be achieved.

However, according to investigations of the inventors, variation in quality of the mixed solution can be generated depending on not only the temperature but also stirring conditions of the mixed solution. More specifically, when there is stirring unevenness in the mixed solution inside the neutralization tank, a neutralization degree of the mixed solution becomes non-uniform, and supplying this mixed solution to a polymerization machine is likely to ultimately cause unpreferable variation in quality of a finally obtained water-absorbent resin. This point is not taken into consideration in Patent Literature 1. The above-described points are not limited to a case of producing a water-absorbent resin by performing a preparation of a mixed solution through neutralization of an acidic substance with a basic substance, but also similarly apply to a case of preparing a mixed solution such that two or more kinds of materials are mixed to a desired degree, or to a case of producing a product other than a water-absorbent resin by preparing a mixed solution.

It is an object of the present invention to provide a mixing apparatus and a method for producing a mixed solution that can suppress variation in the quality of the mixed solution to be produced.

### Solutions to the Problems

A mixing apparatus according to a first aspect of the present invention includes a material supply line, a mixing tank, a stirring device, and a transportation line. The material supply line supplies two or more kinds of materials including a liquid. The mixing tank accommodates the two or more kinds of materials that have been supplied through the material supply line. The stirring device stirs a mixed solution of the two or more kinds of materials inside the mixing tank. The transportation line is connected to the mixing tank and transports the mixed solution inside the mixing tank to an outside of the mixing tank. The mixing apparatus is configured to maintain a liquid level height of the mixed solution inside the mixing tank at a level falling within a predetermined range by controlling at least one of a supply amount of the two or more kinds of materials to be supplied into the mixing tank through the material supply line and a transportation amount of the mixed solution to be transported to the outside of the mixing tank through the transportation line.

According to the mixing apparatus of the first aspect, at least one of the supply amount of the materials including the liquid to the mixing tank and the transportation amount of the mixed solution to be transported from the mixing tank to the outside is controlled so as to maintain the liquid level height of the mixed solution inside the mixing tank at a level falling within a predetermined range. This allows the stirring by the stirring device to be applied in a generally constant manner to the mixed solution inside the mixing tank, and thus, variations in the quality of the mixed solution due to stirring unevenness are suppressed.

In the mixing apparatus according to a second aspect of the present invention, which is the mixing apparatus according to the first aspect, the stirring device includes: a shaft portion rotatable inside the mixing tank, and one or a plurality of stirring blades joined to the shaft portion, the stirring blade rotating inside the mixing tank in association with rotation of the shaft portion. When a height along a vertical direction from a lowermost position of a bottom portion of the mixing tank to an upper end of the stirring blade at an uppermost position is H1, the mixing apparatus is configured to maintain the liquid level height such that the liquid level height becomes equal to or less than 1.21 H1 and equal to or more than a height of a lower end of the stirring blade at the uppermost position.

According to the mixing apparatus of the second aspect, an upper limit of the liquid level height is set with the height of the upper end of the stirring blade at the uppermost position as a reference, and a lower limit of the liquid level height is set with the height of the lower end of the stirring blade at the uppermost position as a reference. This allows the stirring by the stirring blade to be surely applied to the liquid level and its vicinity, and thus, the variations in the quality of the mixed solution due to the stirring unevenness are suppressed.

In the mixing apparatus according to a third aspect of the present invention, which is the mixing apparatus according to the first aspect or the second aspect, the transportation line is connected to a lower discharge port formed in a lower portion of the mixing tank, and the transportation line has a return line that returns the mixed solution discharged from the lower discharge port back into the mixing tank from an upper side of the mixing tank.

According to the mixing apparatus of the third aspect, the mixed solution discharged from the lower discharge port of the mixing tank is returned from the upper side of the mixing tank back to the mixing tank through the return line. This increases the stirring effect of the entire mixed solution and makes the mixed solution more homogeneous.

In the mixing apparatus according to a fourth aspect of the present invention, which is the mixing apparatus according to any one of the first aspect to the third aspect, the mixing apparatus is configured to maintain the liquid level height of the mixed solution inside the mixing tank at a level falling within a predetermined range by controlling at least one of the supply amount of the two or more kinds of materials to be supplied to the mixing tank through the material supply line, a return amount of the mixed solution to be returned to the mixing tank through the return line, and the transportation amount of the mixed solution to be transported from the mixing tank to another apparatus through the transportation line.

In the mixing apparatus according to a fifth aspect of the present invention, which is the mixing apparatus according to the third aspect or the fourth aspect, the material supply line has a first opening for discharging the two or more kinds of materials into the mixing tank on the upper side of the mixing tank, the return line has a second opening for discharging the mixed solution into the mixing tank on the upper side of the mixing tank, and when a transverse cross-section of the mixing tank is divided into six regions at intervals of 60 degrees with a central axis of the mixing tank as a reference, and a first virtual region to a sixth virtual region adjacent to one another in clockwise order are specified, the mixing apparatus is configured such that the two or more kinds of materials are discharged through the first opening onto a liquid level of the mixed solution present in at least one of the first virtual region and the second virtual region, the mixed solution that have been returned through the second opening is discharged onto a liquid level of the mixed solution present in at least one of the fourth virtual region and the fifth virtual region, and discharge of the two or more kinds of materials through the first opening and discharge of the mixed solution through the second opening is undone onto a liquid level of the mixed solution present in the third virtual region and the sixth virtual region.

According to the mixing apparatus of the fifth aspect, at the liquid level of the mixing tank, the region into which the two or more kinds of materials are discharged and the region into which the returned mixed solution is discharged are sufficiently separated. This makes it easier for the discharged materials to be mixed with one another at and near the liquid level of the mixed solution, and thus, generation of a local bias in the concentration distribution due to the supply of the materials is suppressed.

A production method of a mixed solution according to a sixth aspect of the present invention includes the following (1) to (4):
(1) supplying two or more kinds of materials including a liquid through a material supply line to a mixing tank connected to the material supply line and a transportation line;
(2) stirring a mixed solution of the two or more kinds of materials inside the mixing tank;
(3) transporting the mixed solution to an outside of the mixing tank through the transportation line; and
(4) maintaining a height of a liquid level of the mixed solution inside the mixing tank at a level falling within a predetermined range by controlling at least one of a supply amount of the two or more kinds of materials to be supplied into the mixing tank through the material supply line and a transportation amount of the mixed solution to be transported to the outside of the mixing tank through the transportation line.

### Advantageous Effects of the Invention

According to the above-described aspects, it is possible to provide a mixing apparatus and a method for producing a mixed solution that can suppress the variation in the quality of the mixed solution to be produced.

### BRIEF DESCRIPTION OF THE DRAWINGS

FIG. 1 is an overall configuration diagram of a mixing apparatus according to one embodiment.

FIG. 2A is a diagram for explaining a virtual region in a mixing tank.

FIG. 2B is a diagram for explaining an additional virtual region in the mixing tank.

FIG. 3 is a block diagram illustrating an electrical configuration of the mixing apparatus.

FIG. 4 is a diagram for explaining heights of a stirring blade and the like.

FIG. 5 is a flowchart illustrating one example of control executed in a production process.

### DESCRIPTION OF EMBODIMENTS

The following describes a mixing apparatus according to one embodiment of the present invention and a method for producing a mixed solution using this mixing apparatus with reference to the drawings. In the following description, a case where a continuous production of a mixed solution by neutralization (including partial neutralization) between an acidic substance and a basic substance is performed using the mixing apparatus according to the one embodiment of the present invention will be described as an example. In this embodiment, the mixed solution produced by the mixing apparatus becomes a water-absorbent resin through a polymerization process and a drying process.

### 1. Mixing Apparatus

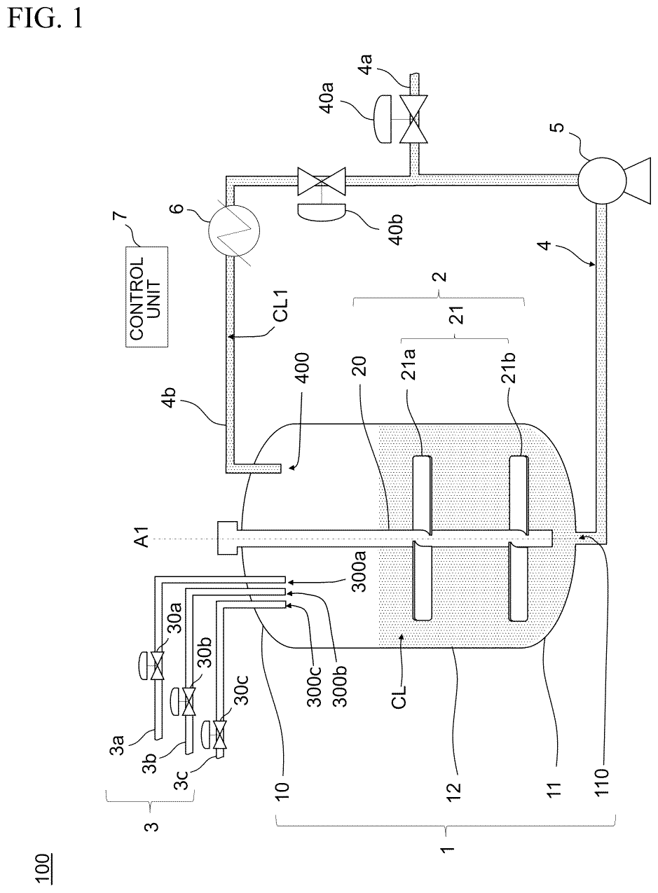

FIG. 1 is an overall configuration diagram of a mixing apparatus 100 according to this embodiment. The mixing apparatus 100 is an apparatus for producing a mixed solution CL containing two or more kinds of materials including a liquid and for continuously sending this to a next process. The mixing apparatus 100 includes a mixing tank 1 for accommodating the mixed solution CL, a stirring device 2 for stirring the mixed solution CL inside the mixing tank 1, a material supply line 3 for supplying the above-described materials into the mixing tank 1, and a transportation line 4 for transporting the mixed solution CL to the outside of the mixing tank 1. The mixing apparatus 100 includes a control unit 7 that controls a production process of the mixed solution CL by controlling operations of the stirring device 2, the material supply line 3, and the transportation line 4. The following describes each element of the mixing apparatus 100.

### [Mixing Tank]

The mixing tank 1 is a container an inner wall surface of which is constituted of a material that is resistant to the mixed solution CL, and in this embodiment, has a substantially cylindrical shape that is circular in a top surface view. The mixing tank 1 is arranged such that its central axis A1 extends along the vertical direction and has a top surface portion 10 facing upward, a bottom surface portion 11 facing downward, and a body portion 12 extending between the top surface portion 10 and the bottom surface portion 11. The mixing tank 1 is connected to the material supply line 3 via the top surface portion 10. As a result, the materials of the mixed solution CL are supplied to the space inside the mixing tank 1 through the material supply line 3. The bottom surface portion 11 is formed with a lower discharge port 110 that is an opening for discharging the mixed solution CL to the outside of the mixing tank 1, and the mixing tank 1 is connected to the transportation line 4 via the lower discharge port 110. During performing the production process, the lower discharge port 110 is opened, and thus, the mixed solution CL continuously flows out into the transportation line 4.

The mixing tank 1 is further connected to a return line 4b via the top surface portion 10. The return line 4b is a branching path branching from the transportation line 4. As described later, at least a part of the mixed solution CL after having been discharged from the mixing tank 1 via the lower discharge port 110 is returned back from an upper side of the mixing tank 1 into the mixing tank 1 through the return line 4b. In the following, the mixed solution CL to be returned into the mixing tank 1 through the return line 4b is referred to as “a mixed solution CL1” for distinction, in some cases.

### [Stirring Device]

The stirring device 2 has a shaft portion 20 that can rotate inside the mixing tank 1 and a stirring blade 21 that is joined to the shaft portion 20 and is entirely housed inside the mixing tank 1. The shaft portion 20 is aligned so as to extend along the central axis A1 of the mixing tank 1 and can be driven by a driving source such as a motor (not illustrated) to rotate around the central axis A1 at a predetermined rotation speed. The stirring blade 21 extends radially outward with the shaft portion 20 as a reference and rotates inside the mixing tank 1 around the shaft portion 20 as the shaft portion 20 rotates. This causes a convective flow in the mixed solution CL, and the mixed solution CL is stirred. The rotation speed of the shaft portion 20 is controlled by the control unit 7.

The stirring blade 21 can be constituted of, for example, one or a plurality of paddles, although it is not limited to this. The paddle has a generally plate-like external shape, and one end is joined to the shaft portion 20 such that its widest surface (a main surface) is inclined with respect to the horizontal direction. An inclination angle of the paddle main surface with respect to the horizontal direction is not particularly limited and may be larger than 0 degrees and equal to or less than 90 degrees and may change midway along the main surface. The main surface of the paddle may include a flat surface or a curved surface. Furthermore, the paddle may include an auxiliary fin. When the stirring blade 21 is constituted of a plurality of puddles, the paddles can be each arranged such that they have equal intervals around the shaft portion 20 as a center at a same position in the vertical direction of the shaft portion 20.

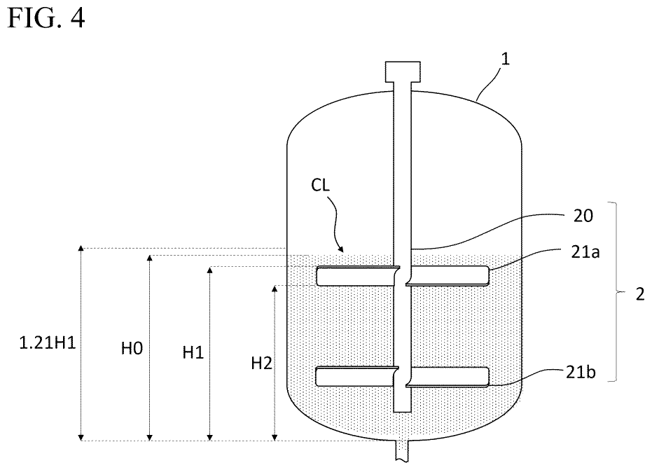

The stirring device 2 may have one stirring blade 21 or may have a plurality of stirring blades 21 arranged at different positions in the vertical direction of the shaft portion 20. The stirring device 2 of this embodiment has two stirring blades 21a and 21b each constituted of a plurality of paddles. The stirring blade 21a is an uppermost stirring blade arranged at a position closer to the top surface portion 10, and the stirring blade 21b is a lowermost stirring blade arranged at a position closer to the bottom surface portion 11. The vertical positions of the stirring blades 21a and 21b are secured during the production process. In the following, the lowermost position of the stirring blade 21a in the vertical direction is referred to as a lower end of the stirring blade 21a, and the uppermost position of the stirring blade 21a in the vertical direction is referred to as an upper end of the stirring blade 21a. A height along the vertical direction from the lowermost position of the bottom surface portion 11 of the mixing tank 1 up to the upper end of the stirring blade 21a is H1, and a height from the same position up to the lower end of the stirring blade 21a is H2 (see FIG. 4).

### [Material Supply Line 3]

The material supply line 3 is a supply path for supplying materials of the mixed solution CL into the mixing tank 1, and in this embodiment, is a generic term for three supply lines 3a to 3c. The supply lines 3a to 3c are each connected to the mixing tank 1. During the production process being performed, a material mainly made of an acidic substance is supplied into the mixing tank 1 from the supply line 3a, a material mainly made of a basic substance is supplied from the supply line 3b, and water is supplied from the supply line 3c. Control valves 30a to 30c are attached to the supply lines 3a to 3c, respectively, and a supply amount of each material can be controlled by the control unit 7 controlling opening and closing amounts of these control valves 30a to 30c. The control valves 30a to 30c may be configured to measure flow rates of the materials in the supply lines 3a to 3c and may be configured to output this to the control unit 7.

In this embodiment, an aqueous solution containing an ethylenically unsaturated monomer is supplied as an acidic substance from the supply line 3a, and an aqueous solution containing a neutralizing agent for the ethylenically unsaturated monomer is supplied as a basic substance from the supply line 3b, respectively. Each of the materials to be supplied from the supply lines 3a to 3c may contain other additive agents. When the materials having been supplied from the supply lines 3a to 3c are accommodated inside the mixing tank 1, the mixed solution CL in which two or more kinds of materials are mixed is produced. Examples of a water-soluble ethylenically unsaturated monomer includes (meth)acrylic acid and its salts, 2-(meth) acrylamido-2-methylpropanesulfonic acid and its salts, (meth)acrylamide, N,N-dimethyl(meth)acrylamide, 2-hydroxyethyl(meth)acrylate, N-methylol(meth)acrylamide, polyethylene glycol mono(meth)acrylate, N,N-diethylaminoethyl(meth)acrylate, N,N-diethylaminopropyl(meth)acrylate, diethylaminopropyl(meth)acrylamide, and the like. Examples of the neutralizing agent includes alkali metal salts such as sodium hydroxide, sodium carbonate, sodium bi carbonate, potassium hydroxide, and potassium carbonate, ammonia, and the like.

The material supply line 3 has a first opening for discharging the materials into the mixing tank 1 on the upper side of the mixing tank 1. In this embodiment, openings 300a to 300c formed in the supply lines 3a to 3c correspond to the first opening. One or a plurality of respective openings 300a to 300c may be formed in each of the supply lines 3a to 3c, respectively. The number of openings 300a to 300c may be the same or different for the supply lines 3a to 3c.

### [Transportation Line]

The transportation line 4 is a transportation path for transporting the mixed solution CL inside the mixing tank 1 to the outside of the mixing tank 1 via the lower discharge port 110 and has a next process line 4a for transporting the mixed solution CL to another apparatus and a return line 4b for returning the mixed solution CL1 back into the mixing tank. The transportation line 4 has a pump 5 and control valves 40a and 40b, and a transportation amount of the mixed solution CL through the next process line 4a is controlled by the control unit 7 controlling a transfer amount of the pump 5 and opening and closing amounts of the control valve 40a. Similarly, a return amount of the mixed solution CL1 through the return line 4b is controlled by the control unit 7 controlling the transfer amount of the pump 5 and opening and closing amounts of the control valve 40b. The control valves 40a and 40b may be configured to measure the flow rate of the mixed solution CL in the next process line 4a and the flow rate of the mixed solution CL1 in the return line 4b, respectively, and to output these flow rates to the control unit 7. The pump 5 may be omitted.

The next process line 4a is connected to another apparatus (not illustrated) other than the mixing apparatus 100, and a next process of the production process is performed in another apparatus. During the production process being performed, the mixed solution CL is transported to another apparatus through the next process line 4a. Thus, the mixed solution CL once transported to the next process line 4a is not returned to the mixing apparatus 100.

The return line 4b has a heat exchanger 6. The heat exchanger 6 is configured to perform temperature adjustment of the mixed solution CL1 transported inside the return line 4b, and the operation of it may be controlled by the control unit 7. In this embodiment, the heat exchanger 6 is configured to remove at least a part of neutralization heat generated in the mixed solution CL1. The heat exchanger 6 may be omitted.

The return line 4b further has a second opening for discharging the mixed solution CL1 that is returned into the mixing tank 1 on the upper side of the mixing tank 1. One second opening may be formed in the return line 4b or a plurality of second openings may be formed in the return line 4b, and in this embodiment, an opening 400 formed in the return line 4b corresponds to the second opening. By at least a part of the mixed solution CL being returned back to the mixing tank 1 as the mixed solution CL1, a neutralization degree of the mixed solution CL becomes more uniform. By the mixed solution CL1 from which the neutralization heat has been removed being returned, a temperature rise of the mixed solution CL inside the mixing tank 1 can be suppressed.

### [Arrangement]

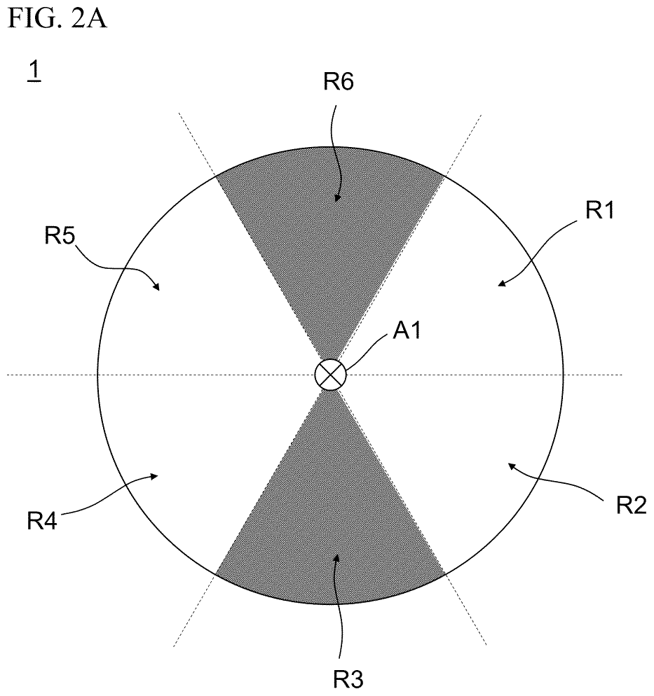

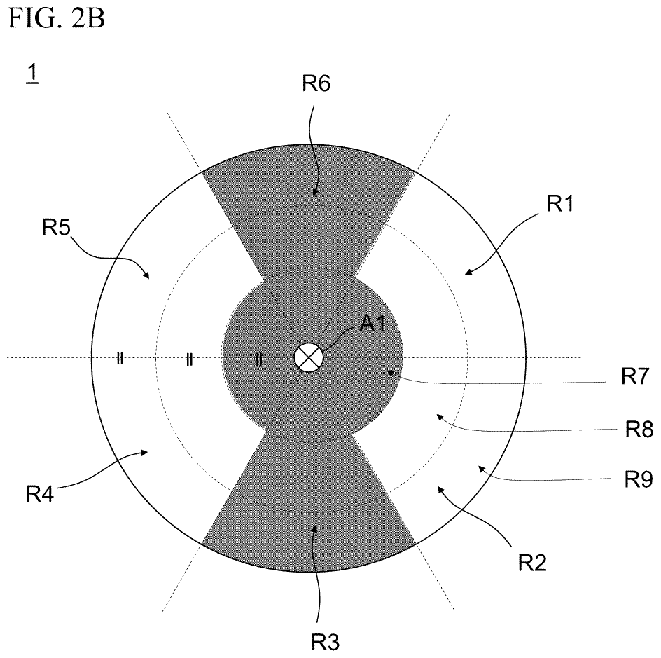

Here, the supply lines 3a to 3c and the return line 4b are preferably configured such that the material discharged into the mixing tank 1 through the openings 300a to 300c and the mixed solution CL1 discharged into the mixing tank 1 through the opening 400 are sufficiently separated from one another. More specifically, as illustrated in FIG. 2A, a transverse cross-section of the body portion 12 is divided into six regions at 60 degrees each with the central axis A1 as a reference, and these divided regions are assumed to be a first virtual region R1 to a sixth virtual region R6 adjacent to each other in clockwise order. At this time, it is preferable that the materials are each discharged through the openings 300a to 300c onto a liquid level of the mixed solution CL present in at least one of the first virtual region R1 and the second virtual region R2, the mixed solution CL1 is discharged through the opening 400 onto a liquid level of the mixed solution CL present in at least one of the fourth virtual region R4 and the fifth virtual region R5, and the materials or the mixed solution CL1 is not discharged onto a liquid level of the mixed solution CL present in the third virtual region R3 and the sixth virtual region R6 (a half-tone dot meshing regions in FIG. 2A).

In addition to the first to sixth virtual regions R1 to R6, when the transverse cross-section of the body portion 12 is divided into three regions in a radially outward direction with the central axis A1 as a reference, and these divided regions are assumed to be a seventh virtual region R7 to a ninth virtual region R9 in an order of proximity to the central axis A1, of the liquid levels of the mixed solution CL present in at least one of the first virtual region R1 and the second virtual region R2, the materials are each discharged through the openings 300a to 300c preferably onto the liquid level present in at least one of the eighth virtual region R8 and the ninth virtual region R9, and more preferably onto the liquid level present in the ninth virtual region R9. In this case, it is preferable that no materials are discharged into the seventh virtual region R7. The seventh to ninth virtual regions R7 to R9 are virtual regions divided such that their lengths in the radially outward direction of the central axis A1 are equal to one another (see FIG. 2B). Similarly, of the liquid levels of the mixed solution CL present in at least one of the fourth virtual region R4 and the fifth virtual region R5, the mixed solution CL1 is discharged through the opening 400 preferably onto the liquid level present in at least one of the eighth virtual region R8 and the ninth virtual region R9, and more preferably onto the liquid level present in the ninth virtual region R9. In this case, it is preferable that no mixed solution CL1 is discharged into the seventh virtual region R7.

According to the investigations of the inventors, by sufficiently separating the discharge region of the materials and the discharge region of the mixed solution CL1 as described above in the liquid level of the mixed solution CL, precipitate generation during the production of the mixed solution CL can be avoided, and thus, the variation in the quality of the mixed solution CL can be suppressed. While the precipitate is, for example, white crystals of the neutralizing agent, and will disappear again by continually stirring the mixed solution CL, it is not efficient to keep the mixed solution CL inside the mixing tank 1 for a long period of time for this reason. The precipitate generation suggests that there is a bias in the neutralization degree of the mixed solution CL (namely, there is variation in quality), and when such mixed solution CL is sent to the next process, it will become a factor that increases the variation in quality of a final product. For this reason, it is preferable to suppress the generation of the precipitate during the production process.

In the mixing apparatus 100 as illustrated in FIG. 1, the inventors have confirmed through experiments that the above-described precipitate is generated when the neutralizing agent aqueous solution and the mixed solution CL1 are discharged onto the liquid level of the mixed solution CL present in one virtual region or two adjacent virtual regions. Specifically, when the neutralizing agent aqueous solution, water, and the mixed solution CL1 were discharged onto the liquid level of the mixed solution CL present in the fourth virtual region and the fifth virtual region R5 in FIG. 2A, and the ethylenically unsaturated monomer aqueous solution was discharged onto the liquid level of the mixed solution CL present in the first virtual region R1 and the second virtual region R2, the generation of the precipitate was confirmed mainly on the inner wall surface of the mixing tank 1 near the fifth virtual region R5. It is believed to be one of the reasons for the generation of such precipitate that the temperature of the neutralizing agent aqueous solution that has reached the liquid level of the mixed solution CL is rapidly decreased by the nearby mixed solution CL1. It is also believed to be one possible reason that the region into which the neutralizing agent aqueous solution is discharged and the region into which the ethylenically unsaturated monomer aqueous solution is discharged are positioned oppositely with one another with respect to the central axis A1, and thus it becomes relatively late until both of them start the neutralization reaction after reaching the liquid level, resulting in causing the localized bias in the neutralization degree.

While the ethylenically unsaturated monomer used in the above-described experiment was acrylic acid monomer, and the neutralizing agent was sodium hydroxide, similar problem is likely to occur when other ethylenically unsaturated monomers and neutralizing agents are used.

From the above-described investigations, the investors have confirmed that when the neutralizing agent aqueous solution, the ethylenically unsaturated monomer aqueous solution, and water were discharged onto the liquid level of the mixed solution CL present in at least one of the first virtual region R1 and the second virtual region R2, and the mixed solution CL1 was discharged onto the liquid level of the mixed solution CL present in at least one of the fourth virtual region R4 and the fifth virtual region R5, no precipitate was generated. This confirmed the effectiveness of sufficiently separating the discharge region of the materials on the liquid level of the mixed solution CL from the discharge region of the mixed solution CL1.

In this embodiment, while the variation in the quality of the mixed solution is suppressed by setting the height of the liquid level of the mixed solution CL1 in the mixing tank at a level falling within a predetermined range, and additionally, the variation in the quality of the mixed solution CL1 is further suppressed by sufficiently separating the discharge region of the materials and the discharge region of the mixed solution CL1 with the above-described arrangement relationship, even when the height of the liquid level of the mixed solution CL1 is not set at a level falling within a predetermined range and it is a mixing apparatus that has only the above-described arrangement relationship, it is possible to suppress the variation in the quality of the mixed solution CL1.

### [Control Unit]

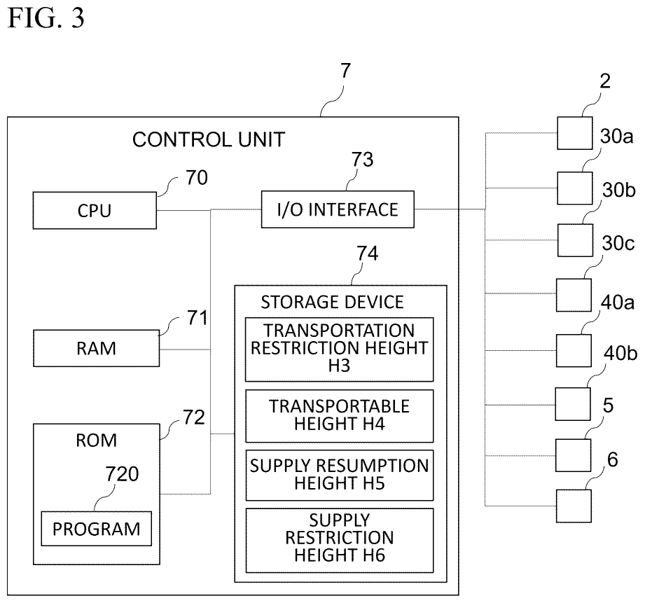

The control unit 7 controls the operation of each element of the mixing apparatus 100 so as to automatically execute the production process. FIG. 3 is a block diagram illustrating an electrical configuration of the control unit 7. The control unit 7 is a general-purpose computer as hardware, and includes a CPU 70, a RAM 71, a ROM 72, an I/O interface 73, and a non-volatile rewritable storage device 74, and these elements are connected to one another by a bus line. The I/O interface 73 is a communication device for communicating with external devices such as the stirring device 2, the control valves 30a to 30c, the control valves 40a and 40b, the pump 5 and the heat exchanger 6, and so on. In the ROM 72, a program 720 for controlling the operation of each element of the mixing apparatus 100 is stored. By the CPU 70 reading out the program 720 from the ROM 72 and executing it, the control unit 7 performs the control described below. The storage device 74 is constituted of a hard disk, a flash memory, and the like. A storage location of the program 720 may be the storage device 74 instead of the ROM 72. The RAM 71 and the storage device 74 are appropriately used for a computation of the CPU 70.

The control unit 7 supplies each material into the mixing tank 1 at a ratio to bring the mixed solution CL to a predetermined neutralization degree by adjusting the opening and closing amounts of the control valves 30a to 30c of the supply lines 3a to 3c, respectively. The control unit 7 transports the required amount of the mixed solution CL to the next process line 4a by adjusting each of the opening and closing amounts of the control valves 40a and 40b of the transportation line 4 and the transfer amount of the pump 5, and also transports the remaining mixed solution CL1 to the return line 4b so as to return it to the mixing tank 1. In this control, a supply amount V1 that is a flow rate of the materials through the supply lines 3a to 3c, a transportation amount V2 that is a flow rate of the mixed solution CL through the next process line 4a, and a return amount V3 that is a flow rate of the mixed solution CL1 through the return line 4b are adjusted so as to maintain a liquid level height H0 of the mixed solution CL inside the mixing tank 1 at a level falling within a predetermined range. Namely, the control unit 7 performs the control for maintaining the liquid level height H0 at a level falling within a predetermined range by controlling V2, which is an irreversible outflow amount to the outside of the mixing tank 1 relative to (V1+V3), which is an inflow amount into the mixing tank 1, or by controlling (V1+V3) relative to V2.

As illustrated in FIG. 4, the liquid level height H0 of the mixed solution CL is the height along the vertical direction from the lowermost position of the bottom surface portion 11 up to the liquid level of the mixed solution CL. Here, the lowermost position of the bottom surface portion 11 refers to the lowermost position in the vertical direction on the inner wall surface of the bottom surface portion 11, and in this embodiment, the peripheral edge portion of the lower discharge port 110 corresponds to the lowermost position of the bottom surface portion 11. The control unit 7 controls at least one of the above-described supply amount V1, transportation amount V2, and return amount V3 such that the liquid level height H0 becomes equal to or more than H2 and equal to or less than 1.21 H1 during the production process being performed. While the specific control processing that the control unit 7 performs will be described later, as parameters for performing this control processing, a transportation restriction height H3, a transportable height H4, a supply resumption height H5, and a supply restriction height H6 are each predetermined and stored in the storage device 74. These parameters are determined to satisfy, for example, H2≤H3≤H4≤H5≤H6≤1.21 H1 although they are not limited to this. It is preferable that the position where the height is H2 and the position where the height is 1.21 H1 are both positions in the body portion 12 of the mixing tank 1.

### 2. Reason why a Liquid Level Height is Maintained at a Level Falling within a Predetermined Range

The following describes the reason why the liquid level heigh H0 of the mixed solution CL is maintained within the above-described range of H2≤H0≤1.21 H1. The inventors have found that, when continuous neutralization of the ethylenically unsaturated monomer aqueous solution with the neutralizing agent aqueous solution is performed using the mixing tank 1, a precipitate is generated on the inner wall surface and the like of the mixing tank 1 when the liquid level height of the mixed solution CL becomes higher than a predetermined level. This precipitate is the crystal of the above-described neutralizing agent and is believed to have been generated due to a local increase of the neutralization degree in the proximity of the neutralizing agent aqueous solution that was discharged from the opening 300b of the supply line 3b and reached the mixed solution CL. As a factor of the local increase of the neutralization degree, in addition to the above-described positional relationship between the discharge region of the materials and the discharge region of the mixed solution CL1, the deviation between the stirring blade 21a and the liquid level is further considered.

Namely, when the liquid level of the mixed solution CL1 becomes higher than the upper end of the stirring blade 21a by a predetermined height or more, a stirring effect of the stirring blade 21a cannot be applied to the liquid level, and a region with a poor convective flow occurs above the stirring blade 21a. By the neutralizing agent aqueous solution being supplied to this region through the opening 300b, a precipitate of the neutralizing agent is generated. Conversely, when the liquid level of the mixed solution CL1 becomes lower than the lower end of the stirring blade 21a, the stirring force of the stirring blade 21a no longer reaches the liquid level, and a region with the poor convective flow is created below the stirring blade 21a and at a predetermined height or more above the stirring blade 21b, and a precipitate of the neutralizing agent is generated similarly to the case where the liquid level becomes high.

Based on the above-described investigations, it has been confirmed by the inventors that when continuous neutralization was performed in the mixing tank 1 while maintaining the liquid level height H0 of the mixed solution CL within the above-described range, no or almost no precipitate was generated. When the inventors analyzed the neutralization degree (mol %) and the concentration (mass %) of the ethylenically unsaturated monomer of a sample of the mixed solution CL1 extracted from the mixing tank 1, it was confirmed that both were within a range of ±0.5% of a target value, and the variation of the neutralization degree of the mixed solution CL was suppressed. This confirmed the effectiveness of maintaining the liquid level height H0 of the mixed solution CL within the above-described range.

While the ethylenically unsaturated monomer used in the above-described investigations was acrylic acid monomer, and the neutralizing agent was sodium hydroxide, even when other ethylenically unsaturated monomers and neutralizing agents are used, maintaining the liquid level height H0 of the mixed solution CL within the above-described range is effective in variation suppression of the neutralization degree.

### 3. Operation of Mixing Apparatus

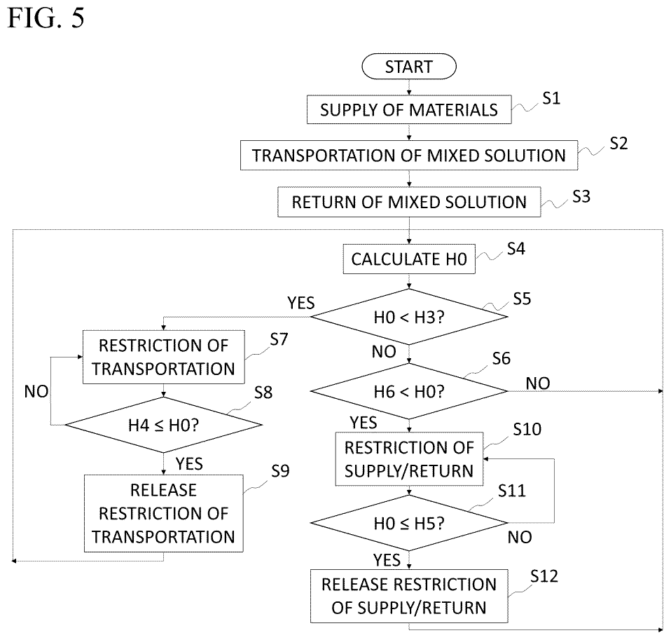

The following describes one example of the control, which is executed in the production process, of the mixing apparatus 100 by the control unit 7. FIG. 5 is a flowchart illustrating a flow of the control of the control unit 7.

In step S1, the ethylenically unsaturated monomer aqueous solution, the neutralizing agent aqueous solution, and water are continuously supplied to the empty mixing tank 1 from the material supply line 3. The supply amount V1 of the materials at this time can be a predetermined specified amount. The control unit 7 rotates the stirring device 2 at a predetermined rotation speed and controls the respective opening amounts of the control valves 30a to 30c such that each material is contained in a predetermined mass ratio in the supply amount V1. The control unit 7 preliminarily controls so as to stop the pump 5 and close the control valves 40a and 40b.

Step S1 continues until the liquid level height H0 of the mixed solution CL reaches the transportable height H4. The time for the liquid level height H0 to reach the transportable height H4, in other words, the time for which step S1 should be continued, is preliminarily determined based on the volume of the mixing tank 1 and the supply amount V1 in step S1 and is stored in the RAM 71 or the storage device 74. Alternatively, the control unit 7 determines this in step S1 and stores it in the RAM 71 or the storage device 74. When the liquid level height H0 reaches the transportable height H4, step S2 is executed.

In step S2, transportation of the mixed solution CL through the next process line 4a starts. The control unit 7 drives the pump 5, opens the control valve 40a, and performs the control so as to transport at least a part of the mixed solution CL discharged from the mixing tank 1 to the next process line 4a. The transportation amount V2 at this time can be a predetermined specified amount.

In step S3, the return of the mixed solution CL1 through the return line 4b starts. The control unit 7 opens the control valve 40b and performs the control such that the mixed solution CL that has not been transported to the next process line 4a is returned into the mixing tank 1 as the mixed solution CL1. The return amount V3 at this time can be a predetermined specified amount.

In step S4, the control unit 7 calculates the current liquid level height H0 of the mixed solution CL based on the supply amount V1 in step S1, the transportation amount V2 in step S2, the return amount V3 in step S3, and the time since the start of each step.

In step S5, the control unit 7 determines whether or not the liquid level height H0 calculated in step S4 is lower than the transportation restriction height H3 (H0<H3). When it is determined that the liquid level height H0 is not lower than the transportation restriction height H3 (NO), step S6 is executed. When it is determined that the liquid level height H0 is lower than the transportation restriction height H3 (YES), step S7 is executed.

In step S6, the control unit 7 determines whether or not the liquid level height H0 calculated in step S4 exceeds the supply restriction height H6 (H6<H0). When it is determined that the liquid level height H0 does not exceed the supply restriction height H6 (NO), step S4 is executed again. When it is determined that the liquid level height H0 exceeds the supply restriction height H6 (YES), step S10 is executed.

In step S7, the control unit 7 restricts the transportation of the mixed solution CL through the next process line 4a. Namely, the control unit 7 controls the control valve 40a to close it so as to stop the transportation of the mixed solution CL or to reduce the transportation amount V2 from the current amount. The control unit 7 controls the control valve 40a to open it so as to increase the return amount V3 from the current amount by the decrease amount in the transportation amount V2. Furthermore, in addition to or instead of this, the control unit 7 controls the control valves 30a to 30c to open them so as to increase the supply amount V1 of the materials through the material supply line 3 from the current amount. Namely, in step S7, at least one of V1 to V3 is controlled such that an outflow amount V2 is reduced relative to an inflow amount (V1+V3). Subsequently, step S8 is executed.

In step S8, the control unit 7 calculates the current liquid level height H0 of the mixed solution CL and determines whether or not the calculated liquid level height H0 has again reached the transportable height H4 (H4≤H0). When it is determined that the liquid level height H0 has reached the transportable height H4 (YES), step S9 is executed. When it is determined that the liquid level height H0 has not reached the transportable height H4 (NO), step S7 is executed again. Namely, step S7 is continued until the liquid level height H0 reaches the transportable height H4 or is repeatedly executed while changing at least one of values of V1 to V3.

In step S9, the control unit 7 releases the restriction on the transportation performed in step S7 and controls the opening and closing amounts of the control valves 30a to 30c and the control valves 40a and 40b such that V1 to V3 become specified values. Subsequently, the processes from step S4 onward are repeatedly executed.

In step S10, the control unit 7 restricts at least one of the supply of the materials through the material supply line 3 and the return of the mixed solution CL1 through the return line 4b. Namely, the control unit 7 controls the control valves 30a to 30c to close them so as to stop the supply of the materials through the material supply line 3 or to reduce the supply amount V1. In addition to or instead of this, the control unit 7 controls the control valve 40b to close it so as to stop the return of the mixed solution CL1 or to reduce the return amount V3. The control unit 7 controls the control valve 40a to open it so as to increase the transportation amount V2 by the decrease amount in the return amount V3. Namely, in step S10, at least one of V1 to V3 is controlled such that the inflow amount (V1+V3) is reduced relative to the outflow amount V2. Subsequently, step S11 is executed.

In step S11, the control unit 7 calculates the current liquid level height H0 of the mixed solution CL and determines whether or not the calculated liquid level height H0 is equal to or less than the supply resumption height H5 (H0≤H5). When it determined that the liquid level height H0 is equal to or less than the supply resumption height H5 (YES), step S12 is executed. When it determined that the liquid level height H0 exceeds the supply resumption height H5 (NO), step S10 is executed again.

Namely, step S10 is continued until the liquid level height H0 becomes equal to or less than the supply resumption height H5 or is repeatedly executed while changing at least one of values of V1 to V3.

In step S12, the control unit 7 releases the restriction on at least one of the supply and the return performed in step S10 and controls the opening and closing amounts of the control valves 30a to 30c and the control valves 40a and 40b such that V1 to V3 become the specified values. Subsequently, the processes from step S4 onwards are repeatedly executed.

By step S1 to step S12 described above being executed in the mixing apparatus 100, it is possible to produce the mixed solution CL in which the bias of the neutralization degree is suppressed.

### 4. Features

According to the mixing apparatus 100 of the above-described embodiment, during the production process being performed, the liquid level height H0 of the mixed solution CL inside the mixing tank 1 is maintained at a level falling within a predetermined range. With this, the stirring by the stirring device 2 is applied almost constantly to the mixed solution CL inside the mixing tank 1, and unevenness of the stirring is reduced, and thus, variations in the quality of the mixed solution CL such as the neutralization degree and the mixing degree are suppressed. Furthermore, an upper limit of the range in which the liquid level height H0 is maintained is set with the upper end of the uppermost stirring blade 21a as a reference. In view of this, by the material supply from the material supply line 3 and the return of the mixed solution CL1 from the return line 4b, the stirring by the stirring blade 21a is applied to the liquid level of the mixed solution CL and its proximity where concentration distribution tends to be biased, and thus, the bias in the concentration distribution and the precipitate generation due to the bias in the concentration distribution can be suppressed. Also, from this point of view, variation in the quality of the mixed solution CL is suppressed.

According to the mixing apparatus 100 of the above-described embodiment, at the liquid level of the mixed solution CL, the discharge region of the materials and the discharge region of the mixed solution CL1 are separated as far apart as possible along the circumferential direction of the mixing tank 1, namely along the rotation direction of the stirring device 2. With this, the neutralization between the supplied materials is accelerated, the local increase in the neutralization degree is suppressed, and thus, the bias in the concentration distribution and the precipitate generation due to the bias in the concentration distribution can be suppressed. It is also possible to suppress the precipitate generation caused by the supplied neutralizing agent aqueous solution being rapidly cooled by the mixed solution CL1.

### 5. Modifications

While the embodiment of the present invention has been described above, the present invention is not limited to the above-described embodiment, and various modifications are possible without departing from the spirit of the present invention.

For example, the following modifications are possible. The gist of the following modifications can be appropriately combined.

(1) In addition to or instead of the time series supply amount V1, transportation amount V2, and return amount V3, the control of the liquid level height H0 may be performed based on the liquid level height H0 measured or observed inside the mixing tank 1. Measurement of the liquid level height H0 can be performed, for example, using a known liquid level sensor, observation of the liquid level height H0 can be performed, for example, by using a captured image of the liquid level by a camera, and by monitoring the captured image by a person or by a computer performing image processing to the captured image.

(2) At least a part of the functions of the control unit 7 may be achieved by a programmable logic device (PLD) or the like, instead of a CPU as in the above-described embodiment. The control processing by the control unit 7 is not limited to the above-described embodiment, and it is only necessary that by controlling at least one of a liquid inflow amount into and a liquid outflow amount out of the mixing tank 1, the liquid level height H0 is maintained at a level falling within a predetermined range.

(3) The shape of the mixing tank 1 is not limited to that in the above-described embodiment. The mixing tank 1 may have, for example, a substantially rectangular cylindrical shape or may have a substantially inverted conical shape. The control valves 30a to 30c and 40a and 40b may be constituted of other types of valves. Furthermore, the return line 4b may be omitted.

(4) The material of the mixed solution CL is only necessary to be two or more kinds of materials including a liquid and is not limited to the above-described embodiment. The mixed solution CL may contain two kinds of materials or may contain four or more kinds of materials. Some of these materials may be supplied in a solid state.

(5) The material supply line 3 does not have to be separated for each material as the supply lines 3a to 3c as in the above-described embodiment and may be constituted such that, for example, at least two of these supply lines join or are integrated into one.

(6) The stirring blade 21 is not limited to that in the above-described embodiment. The stirring blade 21 can be, for example, a helical ribbon type, an anchor type, a turbine blade type, an umbrella type, or the like. Also in this case, similarly to the above-described embodiment, the liquid level height H0 of the mixed solution CL can be controlled based on the height in the vertical direction of the lower end and upper end of the stirring blade 21.

(7) The mixing apparatus 100 and the production process of the above-described embodiment are not limited to the case of producing a mixed solution by neutralizing and partially neutralizing an acidic substance with a basic substance but can also be applied to a case of producing a mixed solution such that two or more kinds of materials are mixed to a desired degree.

### REFERENCE SIGNS LIST

1 Mixing tank
2 Stirring device
3 Material supply line
3a to 3c Supply line
4 Transportation line
4a Next process line
4b Return line
5 Pump
6 Heat exchanger
7 Control unit
10 Top surface portion
11 Bottom surface portion
12 Body portion
20 Shaft portion
21, 21a, 21b Stirring blade
30a to 30c, 40a, 40b Control valve
100 Mixing apparatus
110 Lower discharge port
300a to 300c Opening (first opening)
400 Opening (second opening)
A1 Central axis
CL, CL1 Mixed solution
H0 Liquid level height
R1 to R9 First to ninth virtual regions
V1 Supply amount
V2 Transportation amount (outflow amount)
V3 Return amount

1.-6. (canceled)

7. A mixing apparatus comprising:
a material supply line that supplies two or more kinds of materials including a liquid;
a mixing tank that accommodates the two or more kinds of materials that have been supplied through the material supply line;
a stirring device that stirs a mixed solution of the two or more kinds of materials inside the mixing tank; and
a transportation line that is connected to the mixing tank and transports the mixed solution inside the mixing tank to an outside of the mixing tank,
wherein the mixing apparatus is configured to maintain a liquid level height of the mixed solution inside the mixing tank at a level falling within a predetermined range by controlling at least one of a supply amount of the two or more kinds of materials to be supplied into the mixing tank through the material supply line and a transportation amount of the mixed solution to be transported to the outside of the mixing tank through the transportation line.

8. The mixing apparatus according to claim 7, wherein the stirring device includes:
a shaft portion rotatable inside the mixing tank; and
one or a plurality of stirring blades joined to the shaft portion, the stirring blade rotating inside the mixing tank in association with rotation of the shaft portion, and
when a height along a vertical direction from a lowermost position of a bottom portion of the mixing tank to an upper end of the stirring blade at an uppermost position is H1, the mixing apparatus is configured to maintain the liquid level height such that the liquid level height becomes equal to or less than 1.21 H1 and equal to or more than a height of a lower end of the stirring blade at the uppermost position.

9. The mixing apparatus according to claim 7, wherein the transportation line is connected to a lower discharge port formed in a lower portion of the mixing tank, and
the transportation line has a return line that returns the mixed solution discharged from the lower discharge port back into the mixing tank from an upper side of the mixing tank.

10. The mixing apparatus according to claim 9, wherein the mixing apparatus is configured to maintain the liquid level height of the mixed solution inside the mixing tank at a level falling within a predetermined range by controlling at least one of the supply amount of the two or more kinds of materials to be supplied to the mixing tank through the material supply line, a return amount of the mixed solution to be returned to the mixing tank through the return line, and the transportation amount of the mixed solution to be transported from the mixing tank to another apparatus through the transportation line.

11. The mixing apparatus according to claim 9, wherein the material supply line has a first opening for discharging the two or more kinds of materials into the mixing tank on the upper side of the mixing tank,
the return line has a second opening for discharging the mixed solution into the mixing tank on the upper side of the mixing tank, and
when a transverse cross-section of the mixing tank is divided into six regions at intervals of 60 degrees with a central axis of the mixing tank as a reference, and a first virtual region to a sixth virtual region adjacent to one another in clockwise order are specified, the mixing apparatus is configured such that the two or more kinds of materials are discharged through the first opening onto a liquid level of the mixed solution present in at least one of the first virtual region and the second virtual region, the mixed solution that have been returned through the second opening is discharged onto a liquid level of the mixed solution present in at least one of the fourth virtual region and the fifth virtual region, and discharge of the two or more kinds of materials through the first opening and discharge of the mixed solution through the second opening is undone onto a liquid level of the mixed solution present in the third virtual region and the sixth virtual region.

12. The mixing apparatus according to claim 8, wherein the transportation line is connected to a lower discharge port formed in a lower portion of the mixing tank, and
the transportation line has a return line that returns the mixed solution discharged from the lower discharge port back into the mixing tank from an upper side of the mixing tank.

13. A production method of a mixed solution, comprising:
supplying two or more kinds of materials including a liquid through a material supply line to a mixing tank connected to the material supply line and a transportation line;
stirring a mixed solution of the two or more kinds of materials inside the mixing tank;
transporting the mixed solution to an outside of the mixing tank through the transportation line; and
maintaining a height of a liquid level of the mixed solution inside the mixing tank at a level falling within a predetermined range by controlling at least one of a supply amount of the two or more kinds of materials to be supplied into the mixing tank through the material supply line and a transportation amount of the mixed solution to be transported to the outside of the mixing tank through the transportation line.
